(19) United States
(12) Patent Application Publication
(10) Pub. No.: US 2014/0279972 A1
(43) Pub. Date: Sep. 18, 2014

(54) CLEANSING AND STANDARDIZING DATA

(71) Applicant: Teradata US, Inc., Dayton, OH (US)

(72) Inventors: Santosh Kumar Singh, Bangalore (IN); Achal Patel, Vadodara (IN); Anand Louis, Bangalore (IN); Venugopal Reddy, Bangalore (IN)

(73) Assignee: Teradata US, Inc., Dayton, OH (US)

(21) Appl. No.: 14/208,044

(22) Filed: Mar. 13, 2014

Related U.S. Application Data
(60) Provisional application No. 61/788,636, filed on Mar. 15, 2013.

(51) Int. Cl. G06F 17/30

(52) U.S. Cl. CPC G06F 17/30289
USPC 707/694

(57) ABSTRACT

Data cleansing and standardization techniques are provided. A user interactively defines rules for cleansing and standardizing data of a source dataset. The rules are applied to the data and varying degrees of results and metrics associated with applying the rules are presented to the user for inspection and analysis.

### RELATED APPLICATIONS

The present application is co-pending with, claims priority to, and is a non-provisional application of Provisional Application No. 61/788,636 entitled: “Techniques for Cleansing and Standardizing Data,” filed on Mar. 15, 2013; the disclosure of which is hereby incorporated by reference in its entirety herein and below.

### BACKGROUND

After over two-decades of electronic data automation and the improved ability for capturing data from a variety of communication channels and media, even small enterprises find that the enterprise is processing terabytes of data with regularity. Moreover, mining, analysis, and processing of that data have become extremely complex. The average consumer expects electronic transactions to occur flawlessly and with near instant speed. The enterprise that cannot meet expectations of the consumer is quickly out of business in today's highly competitive environment.

Because of the massive collection of data from a variety of sources, enterprises also face significant integration/interoperability issues. That is, the data and the sources of data are exploding at rates that prevent the enterprise from fully integrating the data. For example, one source of data may have no discernible field or record keys; such that manual inspection of the data becomes a necessity to properly integrate the data with other related data within the enterprise. The data sources that an enterprise is attempting to integrate may be voluminous as well, adding to the manual efforts of the enterprise. Still further, some fields within a data source may lack identifying data or may misidentify data, which also complicates integration tasks.

Often problems arise when integrating multiple data sources within an enterprise, such as: dirty data, duplicate data, and data in formats not recognized by other enterprise systems such that the data cannot be automatically processed. Fixing data errors, removing duplicate data items, and standardizing data entail a significant amount of manual labor. As a result, may enterprises may forgo these tasks and the underlying value of the data because the expense is too high for the enterprise to endure.

Thus, there is a need to more efficiently and timely cleaning and standardizing large amounts of data from disparate data sources.

### SUMMARY

In various embodiments, data cleansing and standardization techniques are presented. According to an embodiment, a method for data cleansing and standardization is provided.

Specifically, a source dataset is obtained and rules to cleanse and standardize the source dataset are acquired. Next, the rules are applied to the source dataset to modify data of the source dataset.

### BRIEF DESCRIPTION OF THE DRAWINGS

FIG. 1 is a diagram of a method for data cleansing and standardization, according to an example embodiment.

FIG. 2 is a diagram of another method for data cleansing and standardization, according to an example embodiment.

FIG. 3 is a diagram of a data cleansing and standardization system, according to an example embodiment.

### DETAILED DESCRIPTION

FIG. 1 is a diagram of a method 100 for data cleansing and standardization, according to an example embodiment. The software module(s) that implement the method 100 are herein referred to as “data manager.” The executable instructions of the data manager are programmed in memory and/or non-transitory computer-readable storage medium, which execute on one or more processors (specifically configured to execute the data manager). Moreover, the data manager has access to one or more networks (wired, wireless, or a combination of both wired and wireless).

Initially, it is noted that specific embodiments and sample implementations for various aspects of the invention are provided in detail in the provisional filing (Provisional Application No. 61/788,636), which is incorporated by reference in its entirety herein. The provisional filing also includes a variety of screen shots that illustrate sample screens for the various Graphical User Interfaces (GUIs), discussed herein and below.

In an embodiment, a “data source” is a relational database table having one or more columns and rows. A row that spans multiple columns of a relational database table is referred to as a “record.” Each column and row includes column identifiers and row identifiers, which provides a reference for what is included in each of the rows and columns. A “cell” is a particular row and column combination and includes data (or no data if empty); so, a record is a horizontal collection of cells. The table, columns, rows, and cells can have a variety of other metadata that describes their contents, individually, as a whole, and/or in collections with one another.

In an embodiment, each of the embodiments discussed herein utilize a relational database.

As used herein “business rules” refer to conditions and actions represented in a data format that can be evaluated and interpreted by the software modules (discussed herein and below) for purposes of performing automated data cleansing and data standardization. In an embodiment, the business rules are hierarchical in nature such that certain rules can override and take precedence over other rules.

Enterprise data is electronic data that is collected, indexed, and housed by an enterprise on one of more storage devices for purposes of analysis and providing services to internal and external customers.

The data includes primary data and secondary data (metadata). Primary data (may also be referred to as “reference data”) relates to data that an enterprise manages to understand aspects of its customers and business operations. Metadata is data about the primary data, such as, but not limited to, data type, data size, data location, data usage, and any business rules associated with the primary data.

A “golden” or “master” record is a single federated, standardized, and cleansed record for a unit of data's lifecycle within the enterprise environment.

Data “cleansing” is modification to the primary data and/or metadata to correct a defined or detected anomaly; this can include duplicate data detection.

Data “standardization is syntactically and semantically putting the primary data and/or metadata in a format that provides consistency and provides usage by consuming applications/services.

The data manager includes one or more Application Programming Interfaces (APIs) for interacting with other automated applications/services within an enterprise and a GUI for interacting with a user.

It is within this initial and brief context, that the processing of the data manager is now discussed with reference to the FIG. 1.

At 110, the data manager a source dataset. That is, a reference to a source dataset that is to be cleansed and standardized is obtained.

In an embodiment, the reference is acquired from a user that is accessing a GUI interfaced to the data manager. The GUI representing a workbench toolkit for the user to interactively and iteratively cleanse and standardized the dataset using the data manager.

In an embodiment, the reference is acquired from an automated application that uses an API to interact with the data manager.

In an embodiment, the source dataset is a relational database.

In an embodiment, the source dataset is a relational database table.

According to an embodiment, at 111, the data manager saves a copy of the source dataset. This can be done in response to the user requesting that the source dataset be modified when the data associated with the source dataset is cleansed and standardized, such that saving a copy ensures the original data can be obtained if necessary (such as when something fails or errors occur or such as when the source dataset has to be maintained for compliance reasons).

At 120, the data manager acquires rules to cleanse and standardize the source dataset. Rules associated with cleansing can include, by way of example only: correcting spelling errors, correcting formatting codes (capitalization, punctuation, etc.), adding content that should include a value (such as 0 for a number when field is null), and the like. Rules associated with standardization can include, by way of example only: changing data types, changing tags or field names, changing the size of fields, and the like.

Moreover, it is noted that in many cases (although not all) data in a source dataset may have consistent content, formatting, and structure that needs to be cleansed and standardized, such that acquisition of the rules permit the cleansing and standardization across rows and/or columns of the data. However, in some instances only certain or sporadic cells need changed and customized rules can be developed to account for this scenario.

According to an embodiment, at 121, the data manager obtains at least some rules from an existing library of available rules. That is, as datasets are cleansed and standardized a repository of rules is maintained and these rules can be reused. The rules can be applied to a single column, sets of columns, all columns, a single row, sets of rows, all rows, or combinations of columns and rows. Also, as mentioned above, in some situations a rule may be applied to specific cells.

In an embodiment, at 122, the data manager obtains at least some of the rules based on user modification to one or more existing rules. That is, the user (via a GUI) can select an existing rule and customize that rule for the source dataset.

In an embodiment, at 123, the data manager obtains at least some rules based on user-created rules. Here, the user creates an entirely new rule (cleansing and/or standardizing using a GUI) for some aspect (row, column, sets of rows and/or columns) of the source dataset.

At 130, the data manager applies the rules to the source dataset to modify data of the source dataset.

According to an embodiment, at 131, the data manager houses the modified data in a target dataset defined by the user; the existing data of the source dataset remains unchanged. This may be a situation where the user did not save the source dataset and does not want the source dataset to be altered during the cleansing and standardization process.

In an embodiment, at 140, the data manager maintains a variety of metrics for the rules, columns modified from the source dataset (and by which rule), and rows modified from the source dataset (and by which rule). Totals for the data set can be established based on all rules, each rule, and/or sets of rules. The totals can be per rule, per column, and per row as well.

In an embodiment of 140 and at 141, the data manager acquires some of the metrics as user-defined metrics. That is, the user can use a GUI to predefine his/her own customized metrics that the user wants to view at the conclusion of cleansing and standardizing the source dataset.

In an embodiment of 141 and at 142, the data manager presents the metrics in an interactive GUI for a user to interact with to obtain varying levels of views of the metrics and details associated with the metrics. The levels can be rolled up across sets of cleansed and standardized datasets or drilled down to specific rules for specific rows, columns, or cells for the source dataset.

In an embodiment, at 150, the data manager presents summary statistics for results associated with applying the rules to the source dataset. This can include totals by rule, by row, by column, actions taken, and the like.

In an embodiment of 150 and at 151, the data manager presents all statistics for all results associated with applying the rules and other rules to the source dataset and other datasets. The statistics are presented in a summary graph for visualization.

In an embodiment, at 160, the data manager presents summary statistics for results associated with a prior execution of the rules against a different data source. This may be particularly useful to the user to see if the rules are accurate and to see how they processed and what the summary is for those prior executions. In fact, the user may elect to use this to determine what rules to use with the source dataset.

It is also to be noted that the processing of the data manager can be iterative permitting the user to keep processing until the user is satisfied with the cleansing and standardization results on the source dataset.

One now appreciates how users can interactively use the data manager as a toolkit to cleanse and standardized data in automated manners. Conventional approaches are largely manual, piecemeal, and ad hoc.

FIG. 2 is a diagram of another method 200 for data cleansing and standardization, according to an example embodiment. The software module(s) that implement the method 200 are herein referred to as “interface manager.” The executable instructions of the probability linker are programmed in memory and/or non-transitory computer-readable storage medium, which execute on one or more processors (specifically configured to execute the interface manager). Moreover, the interface manager has access to one or more networks (wired, wireless, or a combination of both wired and wireless).

The interface manager presents another, and perhaps, enhanced processing perspective of the data manager, presented above with respect to the FIG. 1.

Similar to the data manager (FIG. 1), the interface manager includes one or more APIs for interfacing with automated applications/services within an enterprise and a customer or user-facing GUI for interacting with a user.

At 210, interface manager interacts with a user to obtain a source dataset and rules to clean and standardize data of the source dataset. This is a GUI-based toolkit that the user uses to interact with the interface manager to identify the source dataset and to identify, create, and/or modify the rules.

In an embodiment, at 211, the interface manager provides the user with a list of available rules based on a select of a column, row, or a combination of a row and a column. The selection is based on the columns and rows of the source dataset, which is presented to the user within the GUI for selection.

In an embodiment of 211 and at 212, the interface manager permits the user to modify a particular rule that was selected from the list of available and existing rules.

In an embodiment at 213, the interface manager permits the user to enter and to create one or more of the rules based on selection of a column, a row, or a combination of a column and a row. The selection made by the user within the GUI from the source dataset.

At 220, the interface manager applies the rules against the data of the source dataset to cleanse and standardize the data.

At 230, the interface manager presents a GUI to the user that summarizes results from applying the rules against the data.

According to an embodiment, at 231, the interface manager provides the GUI as an interactive interface that the user can abstract up to get rollup statistics and metrics and that the user can drill down into to get specific statistics and metrics. The level of detail can be across datasets for an entire enterprise and based on rules, columns, rows, etc. Moreover, the level of detail can be for a specific rule on a specific column, row, or cell in the source dataset.

FIG. 3 is a diagram of a data cleansing and standardization system 300, according to an example embodiment. The components of the data cleansing and standardization system 300 are implemented as one or more software modules having executable instructions that are programmed within memory and/or non-transitory computer-readable storage media and that execute on one or more processing nodes (processors) of a network. Furthermore, the data cleansing and standardization system 300 has access to one or more networks. The network is wired, wireless, or a combination of both wired and wireless.

In an embodiment, the probabilistic record linking system 300 implements, inter alia, the methods 100 and 200 of the FIGS. 1 and 2.

The data cleansing and standardization system 300 includes: one or more processors 301, a data cleanser and standardizer module 302, and, optionally, an interface module 303.

The processor(s) 301 have access to memory and/or non-transitory computer-readable storage media to execute the data cleanser and standardizer module 302 and the interface module 303. Each module 302 and 303 comprised of executable instructions that are programmed into the memory and/or the non-transitory computer-readable storage media.

The data cleanser and standardizer module 302 is adapted and configured to: execute on the processor(s) 301, interact with a user to define a source database and rules to cleanse and standardize data within the source database, apply the rules to the data of the source database, and present summary results to the user after the rules are applied.

In an embodiment, the source database is a relational database or relational database table.

In an embodiment, the data cleanser and standardizer module 302 is the data manager of the FIG. 1.

In an embodiment, the data cleanser and standardizer module 302 is the interface manager of the FIG. 2.

In an embodiment, the data cleanser and standardizer module 302 is a combination of the data manager (FIG. 1) and the interface module (FIG. 2).

The interface module 303 is adapted and configured to execute on the processor(s) 301 and provide a GUI to the user for interacting with the data cleanser and standardizer module 302.

According to an embodiment, the interface module 303 is further operable to provide the summary results within the GUI as one or more graphs that can be interacted with by the user to obtain higher and lower level details relevant to the summary results.

In an embodiment, the interface module 303 is the interface manager of the FIG. 1.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
obtaining, by a data manager executing on one or more processors, a source dataset;
acquiring, by the data manager, rules to cleanse and standardize the source dataset; and
applying, by the data manager, the rules to the source dataset to modify data of the source dataset.

2. The method of claim 1, wherein obtaining further includes saving a copy of the source dataset.

3. The method of claim 1, wherein acquiring further includes obtaining at least some rules from an existing library of available rules.

4. The method of claim 1, wherein acquiring further includes obtaining at least some rules based on user modification to one or more existing rules.

5. The method of claim 1, wherein acquiring further includes obtaining at least some rules based on user-created rules.

6. The method of claim 1, wherein applying further includes housing the modified data in a target dataset defined by a user, leaving existing data of the source dataset unchanged.

7. The method of claim 1 further comprising, maintaining, by the data manager, metrics for the rules, columns modified from the source dataset, and rows modified from the source dataset.

8. The method of claim 7, wherein maintaining further includes acquiring at least some of the metrics as user-defined metrics.

9. The method of claim 8 further comprising, presenting, by the data manager, the metrics in an interactive graphical user interface (GUI) for a user to interact with to obtain different levels of views on the metrics.

10. The method of claim 1 further comprising, presenting, by the data manager, summary statistics for results associated with applying the rules to the source dataset.

11. The method of claim 10 further comprising, presenting, by the data manager, all statistics for all results associated with applying the rules and other rules to the source dataset and other datasets, the statistics presented in a summary graph.

12. The method of claim 1 further comprising, presenting, by the data manager, summary statistics for results associated with a prior execution of the rules against a different source dataset.

13. A method, comprising:
interacting, by an interface managing executing on one or more processors, with a user to obtain: a source dataset and rules to clean and standardize data of the source dataset;
applying, by the interface manager, the rules against the data of the source dataset; and
presenting, by the interface manager, a graphical user interface (GUI) to the user summarizing results from applying the rules.

14. The method of claim 13, wherein interacting further includes providing the user a list of available rules based on a selection of a column or a row selected by the user within the source dataset, the user selecting a particular rule from the list of available rules.

15. The method of claim 14, wherein providing further includes permitting the user to modify the particular rule.

16. The method of claim 13, wherein interacting further includes permitting the user to enter and to create one or more of the rules based on a selection of a column or a row selected by the user within the source dataset.

17. The method of claim 13, wherein presenting further includes providing the GUI as an interactive interface that the user can abstract up to get rollup statistics and metrics and drill down into to get specific statistics and metrics.

18. A system, comprising:
a processor having a data cleanser and standardizer module; and
the data cleanser and standardizer module, the data cleanser and standardizer module adapted and configured to (i) execute on the processor; (ii) interact with a user to define a source database and rules to cleanse and standardize data within the source database; (iii) apply the rules to the data; and (iv) present summary results to the user after the rules are applied.

19. The system of claim 18 further comprising, an interface module, the interface module operable to (i) execute on the processor and (ii) provide a graphical user interface (GUI) to the user for interacting with the data cleanser and standardizer module.

20. The system of claim 19, wherein interface module is further operable to: (iii) provide the summary results within the GUI as one or more graphs that can be interacted with by the user to obtain higher and lower level details relevant to the summary results.
